(19) United States
(12) Patent Application Publication
(10) Pub. No.: US 2019/0100391 A1
(43) Pub. Date: Apr. 4, 2019

(54) Transport, Loading and Storage System for Granular Materials

(71) Applicant: Solaris Oilfield Site Services Operating LLC, Houston, TX (US)

(72) Inventor: William Vaughn Managan, II, Early, TX (US)

(21) Appl. No.: 16/143,742

(22) Filed: Sep. 27, 2018

Related U.S. Application Data
(60) Provisional application No. 62/565,507, filed on Sep. 29, 2017.

(51) Int. Cl. B65G 67/24; B65D 88/54; B65G 47/19

(52) U.S. Cl. CPC B65G 67/24; B65D 88/30; B65G 47/19; B65D 88/548

(57) ABSTRACT

The present invention relates to the use of a storage and transfer device to unload granular material from a bottom exit of a tractor trailer bed into a surge hopper, through a transfer device and into a high velocity air stream used to convey the material into a designated silo. Certain embodiments mount the components of the storage and transfer device on a trailer, wherein the transfer device includes a surge hopper, a transfer device, a blower, and a transfer pipe.

### BACKGROUND OF THE INVENTION

### Field of the Invention

The present invention relates to a system and method for transferring granular materials from a tractor trailer bed through a surge hopper and then into a silo at a remote location. In particular, the present invention relates to the use of a storage and transfer device to unload granular material from a bottom exit of a tractor trailer bed into a surge hopper, through a transfer device and into a high velocity air stream used to convey the material into a designated silo.

### Description of the Related Art

Granular material, such as sand, is used in bulk quantities in a number of applications. For example, mining companies sometimes make use of a technique termed “hydraulic fracturing” to aid in the extraction of fossil fuels from well sites. Hydraulic fracturing is the propagation of fractures in a rock layer caused by the presence of a pressurized fluid.

Typically, tractor trailer rigs are used to transport these granular materials to well sites. If no or insufficient storage space is available at the well site, it is oftentimes necessary to store the materials in the same tractor trailer rigs that delivered the materials to the well site. This is an inefficient and frequently cost-prohibitive solution to the storage problem because the trailers must be parked until needed. This is costly because the drivers and their trucks are forced to waste valuable time out of service. Thus, the efficient storage of materials at oil and natural gas well sites is a critical factor in the successful implementation of fracking operations.

There is an existing need for an efficient means for storing more material at remote locations for fracking operations

### SUMMARY OF THE INVENTION

Embodiments of the present invention include a method and system for transporting and storing large quantities of granular material at a remote location. In particular, the present invention relates to the use of a system and method for transferring granular materials from a tractor trailer bed via a conveyor and into a surge hopper. The granular material is then transferred into a silo by dropping portions of the granular materials from the surge hopper into a transfer device and then into an air stream having a high enough pressure to suspend the granular materials and transfer the suspended granules into the silo.

One embodiment of the present invention is a storage and transfer unit comprising: a surge hopper; a transfer device; a blower; and a transfer pipe. The storage and transfer unit may also have a conveyor that is either a pneumatic conveyor or a conveyor belt.

Another embodiment of the present invention is a transfer system for transferring granular material from a tractor trailer bed to a silo, the transfer system comprising: (a) a conveyor having a first end positioned under a bottom exit of the tractor trailed bed and a second end positioned over a top of a surge hopper; (b) a transfer device connected at a top end to the surge hopper and connected at a bottom end to a transfer pipe; (c) a blower connected to a first end of the transfer pipe, wherein the blower pumps a positive pressure air stream through the transfer pipe; and (d) a silo connected to a second end of the transfer pipe.

Yet another embodiment of the present invention is a method for transferring granular materials from a tractor trailer bed to a silo, the transfer method comprising: (a) positioning a storage and transfer unit between the tractor trailer bed and the silo, wherein the storage and transfer unit includes a surge hopper, a transfer device, a blower, and a transfer pipe; (b) positioning a first end of a conveyor under a bottom exit of the trailer bed and a second end of the conveyor over the surge hopper; (c) activating the conveyor; (d) connecting a first end of the transfer pipe to a fill tube of the silo; (e) turning on the blower; (f) releasing portions of the granular material from the bottom exit of the trailer bed onto the conveyor; (g) loading the material on the conveyor into a top end of the surge hopper; (h) releasing portions of the granular material from the bottom exit of the surge hopper into the transfer device; (i) coordinating the operation of a set of four valves, wherein each valve controls the opening and closing of a sealable opening in the transfer device to control the transfer of the granular material from the transfer device into the transfer pipe; and (j) blowing the granular material through the transfer pipe, through the fill tube of the silo and into the silo.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. The foregoing has outlined rather broadly several aspects of the present invention in order that the detailed description of the invention that follows may be better understood.

### BRIEF DESCRIPTION OF THE DRAWINGS

Appended FIGS. 1-7 depict certain non-limiting embodiments of the transport, loading and storage system. The figures are not intended to limit the scope of the invention but, instead, are intended to provide depictions of specific embodiments, features and non-limiting characteristics of the systems described herein. The accompanying figures further illustrate the present invention. The components of an embodiment shown in the drawings are not necessarily drawn to scale, emphasis instead being placed upon clearly illustrating the principles of the present invention.

FIG. 1 depicts a schematic of one embodiment of a system for transferring granular materials from a trailer of a tractor trailer rig into a silo.

FIG. 2 depicts a plan view of one embodiment of the transfer and storage system of granular materials.

FIG. 3 depicts a schematic view of one embodiment of the transfer device.

FIGS. 4A-4D illustrate a series of steps using the embodiment of the transfer device shown in FIG. 3 to transfer portions of granular material from a hopper to a transfer line having a positive pressure air stream that suspends the granular material in the air stream and transfers it to a silo.

FIG. 5 is a flowchart illustrating a process for monitoring the content levels within the silos.

FIG. 6 is a flowchart illustrating a process for monitoring the content level within the surge hopper.

FIG. 7 is a flowchart illustrating a process for controlling the mobile transfer system.

### DESCRIPTION OF THE PREFERRED EMBODIMENTS

The present invention relates to a system and method for transporting and storing large quantities of granular material at a remote location. In particular, the present invention relates to the use of a system and method for transferring granular materials from a tractor trailer bed into a silo by dropping portions of the granular materials into an air stream having a high enough velocity to suspend the granular materials and transfer the suspended granules into a silo.

Unless specifically defined herein, all technical and scientific terms used have the same meaning as commonly understood by one of ordinary skill in the art to which this invention belongs. The term “granular material” is used to define a flowable material comprising solid macroscopic particles, such as sand, gravel, or the like.

As used herein, the term “about” refers to a +/−10% variation from the nominal value. It is to be understood that such a variation is always included in a given value provided herein, whether or not it is specifically referred to.

As used herein, the term “device” is an apparatus configured to perform a particular function.

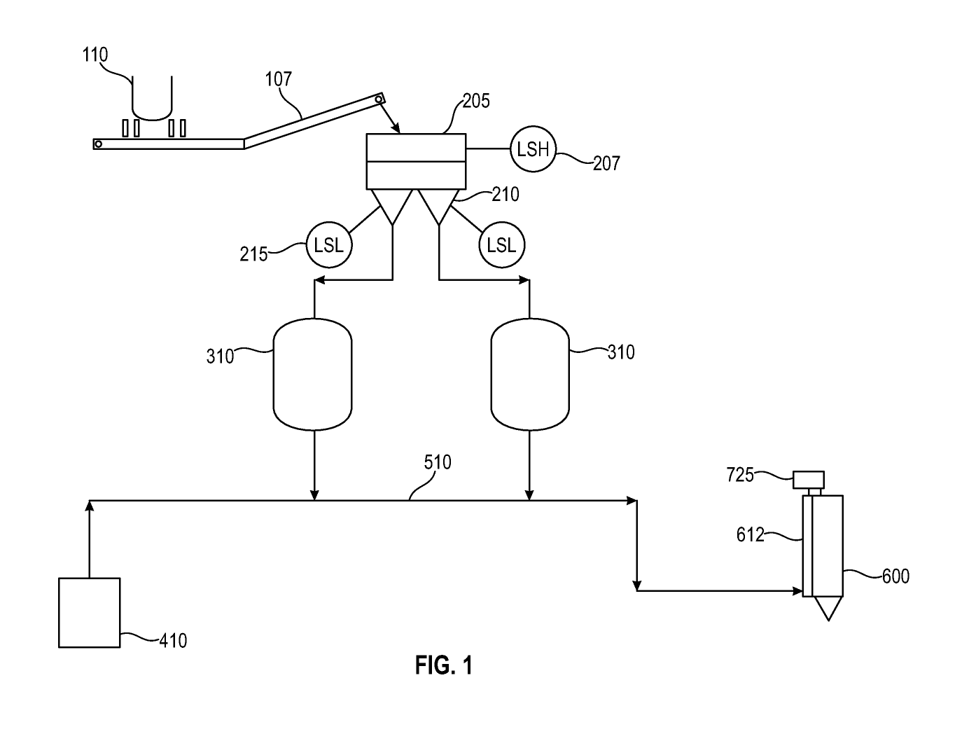

One aspect of the granular transfer system as described herein is shown in FIG. 1. This embodiment includes an onsite tractor trailer rig 110 with a conveyor 107 centered under a bottom exit of the trailer 110 for transferring granular material from the trailer bed to a surge hopper 205. The granular material is then transferred into a silo by dropping portions of the granular materials from the surge hopper into a transfer device 310 and then into a transfer pipe 510. A blower 410 pumps a positive pressure air stream through the transfer pipe. The air stream having a high enough pressure to suspend the granular materials and transfer the suspended granules into a silo 600.

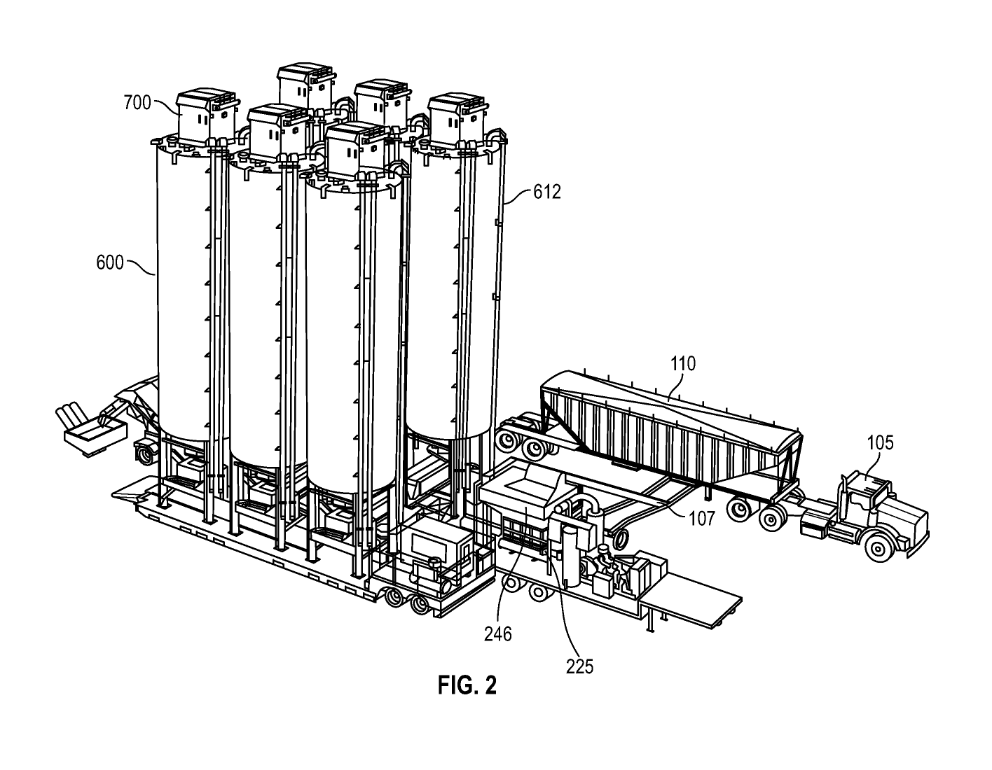

Another aspect of the invention is a portable storage and transfer trailer 225 as illustrated in FIG. 2. The portable storage and transfer trailer 225 has a surge hopper 205, a transfer device 310, a blower 410, and a transfer pipe 510.

Storage of Granular Materials at a Remote Site

One embodiment of a remote site storage system is illustrated in FIG. 2. The storage system includes a plurality of mobile storage containers 600, also referred to herein as silos, arranged on one or more base platforms. FIG. 2 shows a plan view of two parallel base platforms where each base platform has three vertically standing silos 600 with their legs secured to the base platform. The platform typically has an operational section with an attached power generator. A power distribution center is included for distribution of power to the silos positioned on the base platforms. The base platform and its associated operational section, with a set of wheels positioned under the operational section, may be transported from one location to another as though it were a trailer by attaching it to a tractor for relocation.

Since each silo of the on site storage system depicted in FIG. 2 provides a separate storage compartment, the operator can house a particular material in one or more silos. Alternatively, for storing large quantities of a component such as sand, each additional six silos greatly increases the on-site storage of that component. For example, if the user is storing sand on-site an additional six silos provides about 2,500,000 pounds of additional storage and enables the pressure pumper to preload large quantities of sand at the remote site. This gives the pressure pumper a competitive advantage in that it eliminates potential delay and demurrage costs by allowing a large on-site inventory of proppant that is immediately available for use.

One or more portable storage and transfer units 225 are used to provide additional on site storage of granular materials. The portable storage and transfer trailer 225 has a surge hopper 205, a transfer device 310, a blower 410, and a transfer pipe 510 as described in more detail below. Using one or more portable storage and transfer trailers on site provides sufficient storage space at the well site, so that the drivers can immediately empty their trucks and be redeployed.

The Silo Storage System. In preferred embodiments, each silo 600 is equipped with a vent 700 at the top or side of the silo to prevent the accumulation of excessive pressure inside the silo. For example, each silo may be equipped with a bin vent style dust filtration unit 700 on top of the silo. Each dust filtration unit is sized to accommodate the filling of a silo from up to four trailers with a granular material such as sand. The dust filtration unit significantly reduces the presence of free-floating dust on location; particularly the health hazards associated with the large amount of silica dust associated with filling one or more silos with sand. The dust filtration unit 700 may be a self-cleaning unit that recycles the dust back into the silo rather than releasing it into the environment.

Furthermore, the silos 600 may contain one or more devices for monitoring the level of their contents. The monitoring devices may be sonic, radar, optical, inductive or mechanical level monitors. Measuring the contents is useful for inventory management, determining and controlling the rate of usage, and avoiding over filling or unexpected empty conditions. Preferred embodiments determine real time variations in the level, volume or weight of the contents of the silos and transmit the level of component in the silo to a programmable logic control unit (PLC) that can automatically slow or stop the outflow of component from a particular silo at a pre-determined level, switch silo flows to ensure the uninterrupted flow of the component, or initiate the refilling of the silo to maintain the silo level of component within predetermined limits.

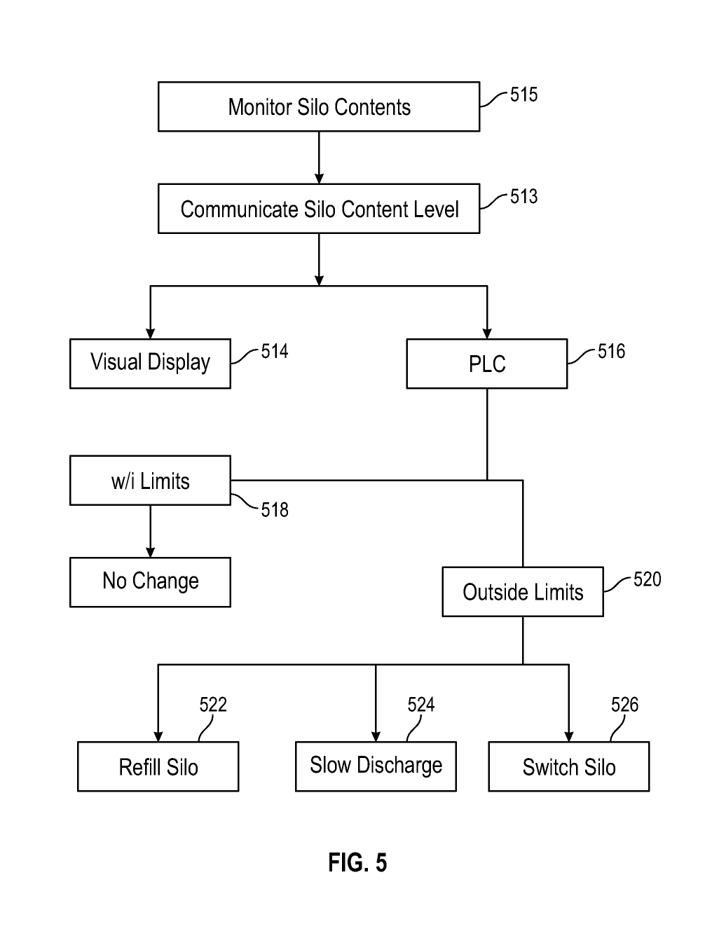

The regulation of the outflow of the component or ingredient from a silo is typically automated. In order to maintain sufficient material levels in the silos it is important to control the inflow of component, or refilling of the silo. The silos 600 typically have one or more fill tubes 612 running up the side of the silo. The tubes 612 facilitate loading the granular component into the silo. As illustrated in FIG. 5, the process of maintaining a sufficient level of material in each silo includes the step of continually monitoring the silo contents level using silo monitors (block 515). The silo levels are communicated (block 513) to a visual display (block 514) and/or to a programmable logic control device or unit (PLC) (block 516). Thus, the PLC constantly acquires real-time silo content level data from the silo level monitors, evaluates the data against stored predetermined component content limits, minimal and maximal limits, and outputs appropriate control signals in the system. If the content level data is within the programmed prescribed limits (block 518) then the PLC will not initiate any change in the blending system. If on the other hand, the silo level contents pass outside of the prescribed limits (block 520), then the PLC sends an alert to the silo technician and/or the system operator. The silo technician or the system operator is responsible for ensuring that the situation is addressed either manually by the silo technician or as instructed by the PLC to initiate refilling the silo (block 522), slowing the discharge from the silo (block 524), or to automatically turn off the discharge of material from a silo with a content level outside of the prescribed limits and to activate the discharge of that component from another silo (block 526).

The Storage and Transfer Unit. One embodiment of a storage and transfer unit 225 is illustrated in FIG. 2. The storage and transfer unit 225 has a surge hopper 205, a transfer device 310, a blower 410, and a transfer pipe 510. Preferred embodiments of the storage and transfer unit mount most of the components needed to transfer the granular materials from the tractor trailer to the silos on a mobile trailer. This mobile transfer system 800 or trailer may have one or more moveable conveyors 107, a surge hopper 205 connected to one or more transfer devices 310, a joining pipe 512, a section of a transfer pipe 510, and connectors to connect the transfer line to the fill pipe 612 of the silo 600, a blower 410, an engine for running the blower, and a battery.

Alternative embodiments of the storage and transfer unit 225 may include a pneumatic conveyor line having a vacuum unit that can produce a negative pressure within the surge hopper whenever it is sealed so that the granular materials can be transferred from the tractor trailer to the surge hopper. The surge hopper may be equipped with a fitted cover 240 designed with a dust collector to reduce the air borne dust during the transfer of materials from the trailer 110 to the surge hopper 205. Some embodiments of the cover 110 may allow the selectable sealing of the surge hopper when a pneumatic conveyor is used.

The use of one or more of the storage and transfer units are an efficient means of expanding the amount of storage space available on site. Furthermore, the use of the storage and transfer units allow for the immediate unloading of the trailers 110 to allow the drivers and their tractor trailers to be efficiently redeployed.

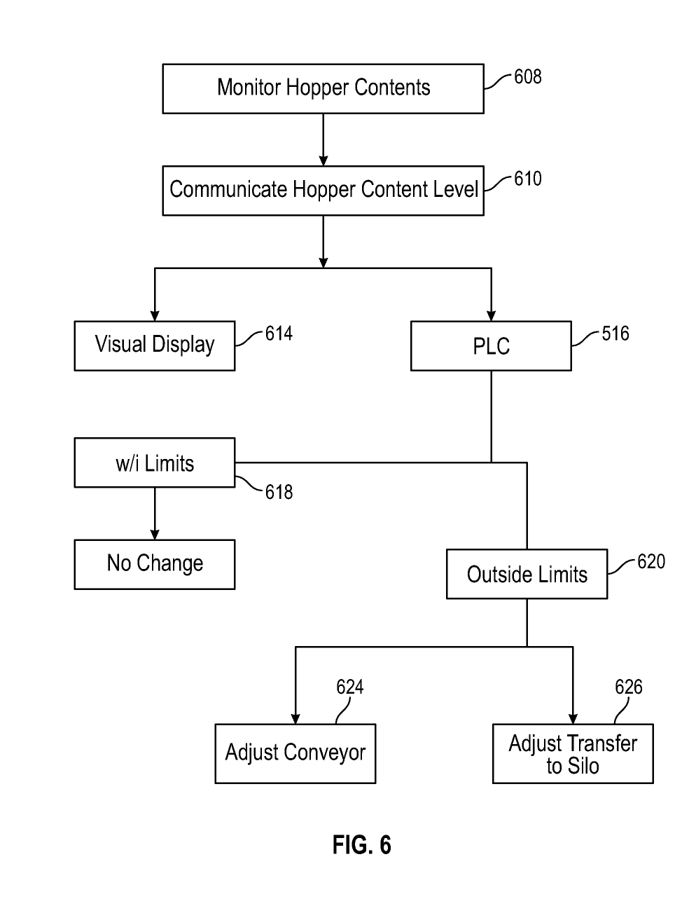

The material from the tractor trailer is initially unloaded into the surge hopper 205. The amount of material in the surge hopper is monitored with level monitors. Generally a first monitor 207 is used to signal when the level of material surpasses a maximum desired height level to prevent over filling the surge hopper. A second monitor 215 is used to signal when the level of material is less that the desired amount in the surge hopper and avoids encountering unexpected empty conditions. Preferred embodiments will determine real time variations in the level of material in the surge hopper and transmit the level of material to a programmable logic control unit (PLC) that can automatically slow or stop the inflow or outflow of material from the surge hopper at pre-determined levels as shown in FIG. 6.

The regulation of the outflow of the granular material from the surge hopper is typically automated. In order to maintain sufficient material levels in the hopper 205 it is important to control the inflow of material, or the filling of the hopper. As illustrated in FIG. 6, the process of maintaining sufficient material levels in the surge hopper includes the step of continually monitoring the hopper content level using an upper monitor 207 and a lower monitor 215 (block 608). The hopper levels are communicated (block 610) to a visual display (block 614) and/or to a programmable logic control device or unit (PLC) (block 516). Thus, the PLC constantly acquires real-time hopper content level data from the hopper level monitors, evaluates the data against stored predetermined hopper content limits, minimal and maximal limits, and outputs appropriate control signals to the system.

If the content level data is within the programmed prescribed limits (block 618) then the PLC will not initiate any change in the inflow/outflow of hopper content. If on the other hand, the hopper content level passes outside of the prescribed limits (block 620), then the PLC sends an alert to the hopper technician and/or the system operator. The hopper technician or the system operator is responsible for ensuring that the situation is addressed either manually by the hopper technician or as instructed by the PLC either to adjust the speed of the conveyor 107 (block 624), thereby increasing or decreasing the rate of inflow of material into the hopper, or to adjust the speed of the transfer of material to the silo (block 626) through the transfer device 310.

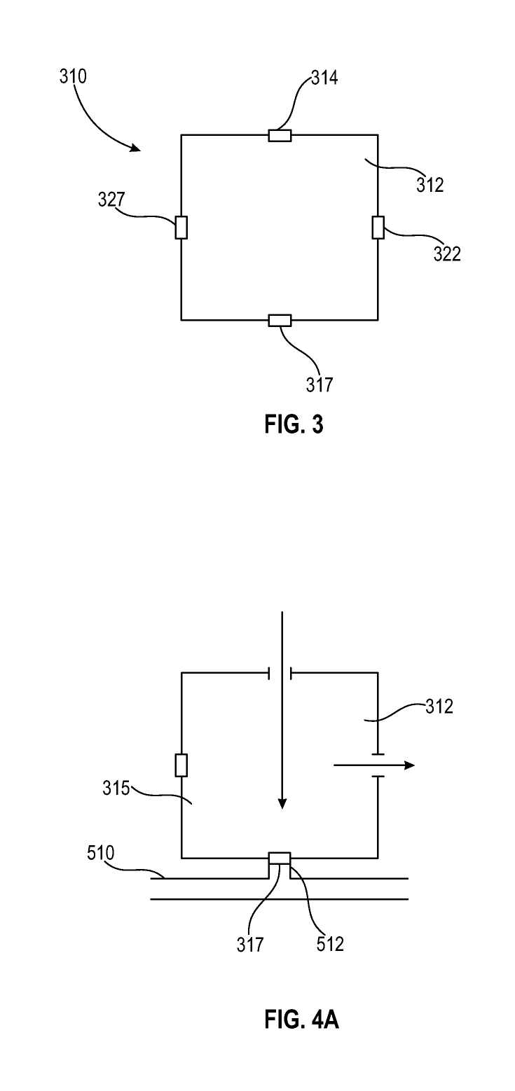

A hopper bottom exit 210 feeds the granular material from the surge hopper into a transfer device 310. The transfer device 310 is schematically illustrated in FIGS. 1 and 3. One embodiment of the transfer device 310, as shown in FIG. 3, has a chamber 312 with a first selectably sealable opening 314 on a top of the chamber that communicates with the surge hopper 205 whenever it is open and a second selectably sealable opening 317 on a bottom of the chamber that communicates with the transfer pipe 510 whenever it is open. The chamber 312 is connected to the surge hopper 205 on one side and is connected to a transfer pipe 510 via a joining pipe 512 on an opposed side. The chamber 312 also has a selectably sealable purge opening 322 and a selectably sealable pressurization opening 327. Each of the selectably sealable openings 314, 317, 322 and 327 may be opened and closed using one or more types of valves.

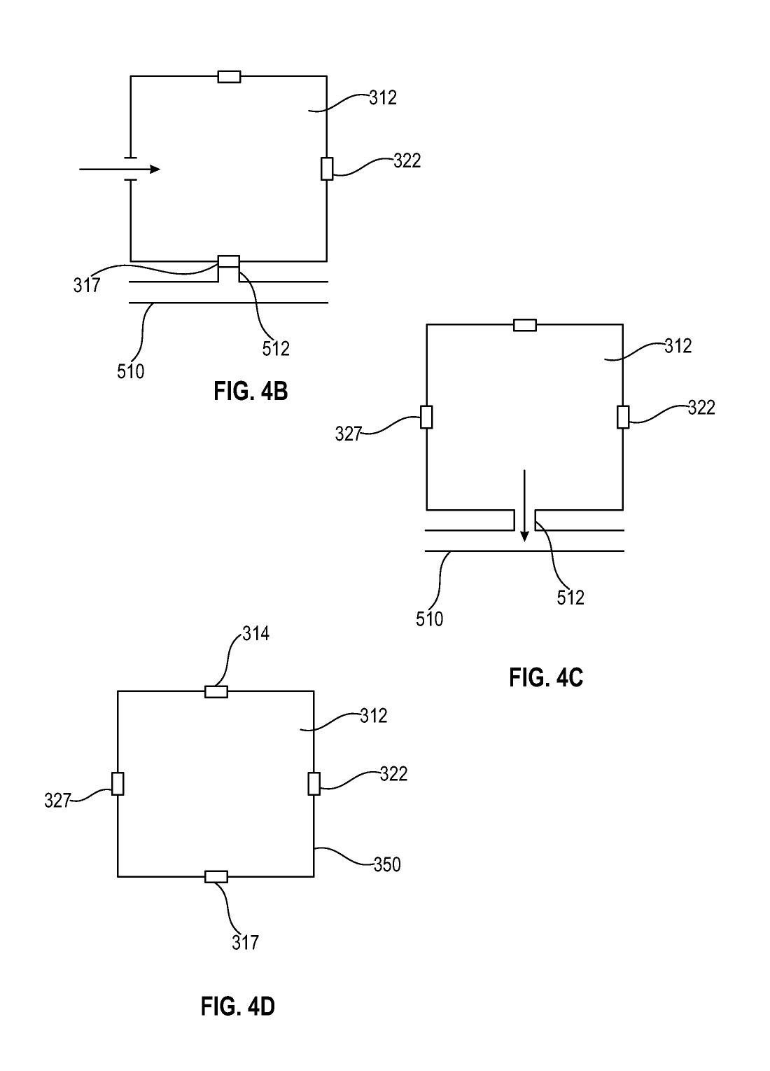

One embodiment of the transfer device 310 operates as illustrated in FIGS. 4A-4D and briefly described below. As shown in FIG. 4A, whenever the first opening 314 and the purge opening 322 are opened the chamber 312 is at atmospheric pressure and a portion of granular material in the surge hopper 205, that is also at atmospheric pressure, drops by gravity into the chamber 312. Once the desired amount of granular material is in the chamber, the first opening 314 and the purge opening 322 are closed and the pressurization opening 327 is opened as shown in FIG. 4B. While the pressurization opening 327 is open the chamber 312 is pressurized to a predetermined pressure by adding pressurized air from the blower into the chamber. Then the second chamber opening 317 is opened. The transfer pipe 510 has a positive pressure high velocity air stream blowing through the pipe from an air blower 410 to the silo 600. The granular material passes through the second opening 317 into the joining pipe 512 and further into the transfer pipe 510 and is suspended in the air stream and transferred to the silo 600.

Once the granular material has passed through the second opening 317, the second opening is closed as shown in FIG. 4D. Closing the second opening 317 leaves the chamber 312 with a positive pressure. In order to re-equilibrate the pressure in the chamber with atmospheric pressure, the purge opening 322 is opened to allow the chamber to return to atmospheric pressure. Once the chamber has stabilized at atmospheric pressure all of the selectably sealable openings are closed, as shown in FIG. 4D, and the transfer device is ready to repeat its transfer sequence as shown in FIGS. 4A-4D. Preferred embodiments of the transfer system will program the PLC to regulate the timing and operation of the sealable openings of the transfer device as well as coordinate the operation of the valves that open and close the openings in a controlled sequence.

The PLC may be programmed to coordinate the operation of multiple transfer devices connected to the same or different trucks 110 or to the same or different silos 600. In addition, the velocity of the air stream passing through the transfer pipe 510 may also be automatically controlled by the PLC so that the air flow has enough pressure/velocity to suspend the granular material within the air stream as it travels along either a horizontal or a vertical path.

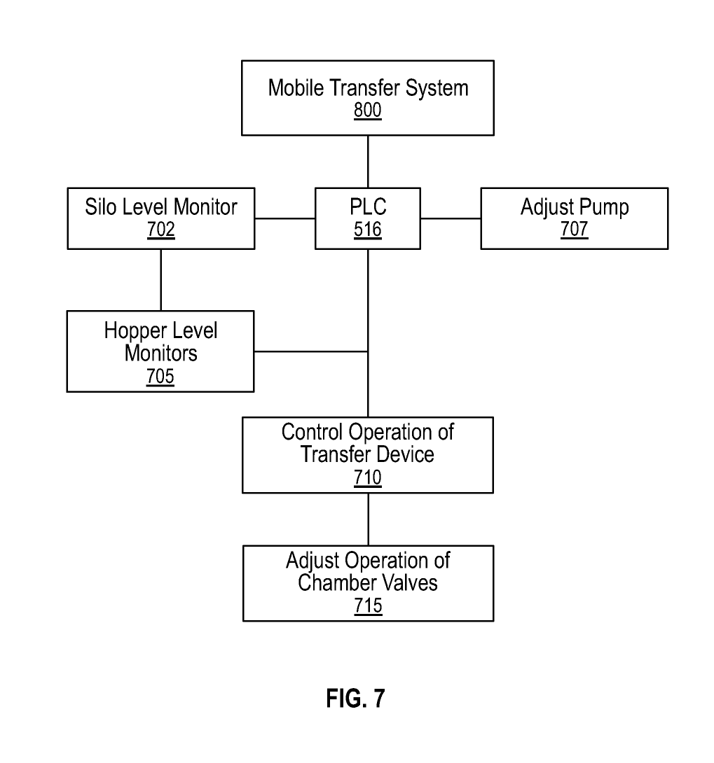

The mobile transfer system 800 schematically illustrated in FIG. 1 can be automatically controlled by the PLC 516 as shown in FIG. 7. The PLC 516 is programmed so that it can be dynamically monitored and different components of the mobile transfer system adjusted to control the transfer process from the truck 110 to a silo 600. For example, as the conveyor is activated and the surge hopper begins to fill with the granular material from the trailer, the surge hopper level monitors are activated. Monitoring both the lowest desired level and the maximum desired level of material in the surge hopper is useful and prevents over filling the surge hopper or encountering unexpected empty conditions (block 705). The programmable logic control unit (PLC) can automatically control the rate of filling or emptying of the surge hopper to maintain the material contents within pre-determined levels and the timing of the granular material passing through the transfer device 310 (block 710) by regulating the timing and operation of the sealable openings 314, 317, 322, and 322 by the chamber valves (block 715) of the transfer device.

Furthermore, the entire transfer of the granular material through the surge hopper into a silo can be coordinated with the level of material in one or more silos. The content level of the silo is monitored (block 702) and sent to the PLC. Whenever the level of material in a silo falls outside of predetermined limits, the transfer of material from the surge hopper to the silo can automatically be initiated to refill the silo. The PLC is programmed to automatically activate the hopper level monitors (block 705) and the pump (block 707). The granular materials are transferred from the surge hopper to the silo by passing through the transfer device and into the transfer pipe. The PLC is programmed to control the operation of the transfer device (block 710) by adjusting the timing and sequence of the chamber valves (block 715). Once the material has passed through the transfer device the high velocity air stream from the pump will send the suspended material up the silo fill pipe 612 and into the silo 600. The velocity of the air stream and therefore the rate of inflow of material into the silo is partially controlled by adjusting the pump (block 707) which can also be automatically controlled by the PLC. In addition, once the silo has been refilled to within predetermined content limits then the PLC can shut off the transfer of material through the mobile transfer system.

Loading Granular Materials from Trailer to Silo at Remote Site

One embodiment of the loading system that transfers the granular material from a tractor trailer rig delivering the granular material to the site to a designated silo is schematically illustrated in FIG. 1. Tractor trailer rigs are used to transport these granular materials to well sites. If no or insufficient storage space is available at the well site, it is often times necessary to store the materials in the same tractor trailer rigs that delivered the materials to the well site. This is an inefficient and frequently cost-prohibitive solution to the storage problem because the trailers must be parked until needed. This is costly because the drivers and their trucks are forced to waste valuable time out of service. Thus, the efficient storage of materials at oil and natural gas well sites is a critical factor in the successful implementation of fracking operations.

A tractor trailer rig 105, with its trailer 110 containing granular material, is driven to the project site and a bottom exit of the trailer is substantially centered over a conveyor 107. The conveyor is activated and transfers the granular material exiting out of the bottom exit of the trailer into a surge hopper 205. The surge hopper may be open to the atmosphere to allow the silos to be loaded from trucks that are not pneumatically equipped. Alternative embodiments of the storage and transfer unit may include a pneumatic conveyor line having a vacuum unit that can produce a negative pressure within the surge hopper, whenever it is sealed, so that the granular materials can be transferred from a pneumatically equipped trailer 110 to surge hopper 105.

Often a tractor trailer rig has two or more bottom exits and therefore a conveyor 107 will be centered under each bottom exit. Then the granular material will be transferred from each of the bottom exits into the surge hopper. Similarly the surge hopper may have two or more bottom exits, each of which will be connected to one or more transfer devices 310.

Thus, whenever a tractor trailer is pulled up to the site to unload into a designated silo, the mobile transfer system is rolled out between the tractor trailer and the silo. If the conveyor(s) are stored on the storage and transfer unit 225, then the conveyors are taken off the transfer unit 225 and centered under each of the bottom exits of the truck. The section of the transfer pipe 510 attached to the storage and transfer unit 225 is connected to the fill pipe 612 of the designated silo and the engine and the blower is turned on. The conveyors are activated and begin to fill the surge hopper.

The storage and transfer unit is programmed so that its operation can be coordinated with the level of material in a silo. The operation of the storage and transfer unit is dynamically monitored and controlled. The different components of the storage and transfer unit 225 can be automatically adjusted to control the transfer process. For example, as the surge hopper begins to fill with the granular material from the trailer, the first and second level monitors (207 and 215 respectively) are activated. Monitoring both the lowest desired level and the maximum desired level of material in the surge hopper is useful and prevents over filling the surge hopper or encountering unexpected empty conditions. Preferred embodiments will determine real time variations in the level of material in the surge hopper and transmit the level of material to a programmable logic control unit (PLC) that can automatically slow or stop the inflow or outflow of material from the surge hopper at pre-determined levels. Preferred embodiments of the transfer system will also program the PLC to regulate the timing and operation of sealable openings of the transfer device as well as coordinate in a controlled sequence the operation of multiple transfer devices. In addition, the velocity of the air stream may also be controlled so that the air flow has enough pressure/velocity to suspend the granular material within the air stream as it travels along either a horizontal or a vertical path.

The foregoing provides a detailed description of the invention which forms the subject of the claims of the invention. It should be appreciated by those skilled in the art that the general design and the specific embodiments disclosed might be readily utilized as a basis for modifying or redesigning the natural gas supply system to perform equivalent functions, but those skilled in the art should realized that such equivalent constructions do not depart from the spirit and scope of the invention as set forth in the appended claims.

What is claimed is:

1. A storage and transfer unit comprising:
(a) a surge hopper;
(b) a transfer device;
(c) a blower; and
(d) a transfer pipe.

2. The storage and transfer unit of claim 1 further comprising a conveyor.

3. The storage and transfer unit of claim 2, wherein the conveyor is a pneumatic conveyor or a conveyor belt.

4. The storage and transfer unit of claim 1 further comprising a selectably sealable cover fitted to cover a top of the surge hopper.

5. The storage and transfer unit of claim 1, wherein the storage and transfer unit is mounted on a trailer.

6. The storage and transfer unit of claim 1, wherein the transfer pipe is connected on one end to the blower and on an opposed end to a fill tube of a silo.

7. The storage and transfer unit of claim 1, wherein the transfer device has a chamber and four selectably sealable openings.

8. The storage and transfer unit of claim 7, wherein a first opening is positioned between the chamber and the surge hopper.

9. The storage and transfer unit of claim 7, wherein a second opening is positioned between the chamber and the transfer pipe.

10. The storage and transfer unit of claim 1, wherein the surge hopper has a first level monitor positioned proximal a top of the surge hopper and a second level monitor positioned proximal a surge hopper bottom exit.

11. A transfer system for transferring granular material from a tractor trailer bed to a silo, the transfer system comprising:
(a) a conveyor having a first end positioned under a bottom exit of the tractor trailed bed and a second end positioned over a top of a surge hopper;
(b) a transfer device connected at a top end to the surge hopper and connected at a bottom end to a transfer pipe;
(c) a blower connected to a first end of the transfer pipe, wherein the blower pumps a positive pressure air stream through the transfer pipe; and
(d) a silo connected to a second end of the transfer pipe.

12. The transfer system of claim 1, wherein the transfer device has a chamber, with an upper valve, a pressurization valve, a purge valve and a lower valve.

13. The transfer system of claim 12, wherein the upper valve is positioned between the chamber and the surge hopper and the lower valve is positioned between the chamber and the transfer pipe.

14. The transfer system of claim 12, wherein a programmable logic control unit coordinates the operation of the upper valve, the pressurization valve, the purge valve and the lower valve.

15. The transfer system of claim 11, further comprising a first monitoring device that dynamically monitors a maximum desired level of material in the surge hopper and a second monitoring device that dynamically monitors a minimum desired level of material in the surge hopper.

16. The transfer system of claim 15, wherein the first and second monitoring devices are in communication with a programmable logic control unit.

17. The transfer system of claim 16, wherein the programmable logic control unit coordinates the transfer of granular material from the surge hopper to the silo with a silo level monitor to ensure that the silo content level is within predetermined limits.

18. A method for transferring granular materials from a tractor trailer bed to a silo, the transfer method comprising:
(a) positioning a storage and transfer unit between the tractor trailer bed and the silo, wherein the storage and transfer unit includes a surge hopper, a transfer device, a blower, and a transfer pipe;
(b) positioning a first end of a conveyor under a bottom exit of the trailer bed and a second end of the conveyor over the surge hopper;
(c) activating the conveyor;
(d) connecting a first end of the transfer pipe to a fill tube of the silo;
(e) turning on the blower;
(f) releasing portions of the granular material from the bottom exit of the trailer bed onto the conveyor;
(g) loading the material on the conveyor into a top end of the surge hopper;
(h) releasing portions of the granular material from the bottom exit of the surge hopper into the transfer device;
(i) coordinating the operation of a set of four valves, wherein each valve controls the opening and closing of a sealable opening in the transfer device to control the transfer of the granular material from the transfer device into the transfer pipe; and
(j) blowing the granular material through the transfer pipe, through the fill tube of the silo and into the silo.

19. The method of claim 18 further comprising the step of covering the surge hopper with a cover, wherein the cover has an entry for the granular material delivered by the conveyor into the surge hopper.

20. The method of claim 18, wherein the coordination of the four valves is controlled by a programmable logic control unit that automatically controls the rate of inflow or outflow of material through the transfer device.
